(19) United States
(12) Patent Application Publication
(10) Pub. No.: US 2009/0265240 A1
(43) Pub. Date: Oct. 22, 2009

(54) COMMODITY PURCHASING SYSTEM

(75) Inventors: Kazuyuki Ikeda, Tokyo (JP); Daisuke Miwa, Tokyo (JP); Makoto Tabei, Tokyo (JP); Kenji Sueyoshi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ASKUL CORPORATION, Tokyo (JP)

(21) Appl. No.: 12/492,505

(22) Filed: Jun. 26, 2009

Related U.S. Application Data
(63) Continuation of application No. PCT/JP2007/075078, filed on Dec. 27, 2007.

(30) Foreign Application Priority Data
Dec. 28, 2006 (JP) 2006-354560

(51) Int. Cl. G06Q 30/00; G06F 17/30; G06F 17/40

(52) U.S. Cl. 705/14.23; 707/100; 705/26; 707/E17.044

(57) ABSTRACT

A group commodity purchasing system for performing a purchasing operation by causing a commodity list to be downloaded and displayed onto a user terminal, the system includes a database of the server contains a commodity master in which at least a commodity code and a price are associated with each other, and a group commodity table for registering a group of commodities selected arbitrarily by a specific user as a group commodity. The server reads a group commodity code from the group commodity table and registering the group commodity code as one of the commodity codes on the commodity master. The group commodity code registered on the commodity master is indicated within the commodity list.

### CROSS-REFERENCE TO RELATED APPLICATIONS

This application is based upon and claims the benefit of priority of the prior Japanese Patent Application No. 2006-354560, filed on Dec. 28, 2006, and the International application No. PCT/JP2007/075078, filed on Dec. 27, 2007, the entire contents of which are incorporated herein by reference.

### FIELD

The present invention relates to a commodity purchasing technique for online shopping in which a commodity is purchased via a network.

### BACKGROUND

Not only in retailing at a store or the like but also in online shopping, it is difficult for a sales site to categorize their commodities so as to satisfy all users' needs because of dealing in a large number of commodities.

However, users have needs to purchase a plurality of commodities in bulk with ease depending upon their purposes for purchasing such as “I want to prepare a set of learning goods for my child's entrance to school” or “I want to purchase all the ingredients for curry rice”, and it has been difficult to satisfy the needs at a one-stop store on a single web site.

That is, as a retail sales web site carries more commodities, it becomes more difficult for the user to make a selection, with a result that the user does not know what to purchase, and excess or deficiency has often occurred in purchasing commodities depending upon his/her purpose.

Particularly in the online shopping through which the user cannot touch an actual commodity, it is impossible to know functionality of the commodity, a size of the commodity, a texture thereof, or the like, and hence a probability of occurrence of excess or deficiency in commodities required according to a purpose of purchase has been high.

In this respect, Patent Document 1 (JP 2002-133291 A) is disclosed as a technique of generating a flexible electronic catalog that matches an ambiguous commodity selecting behavior of each user.

In this technique, a subjective image classifying screen in which a plurality of image pictures each of which may cause users to have a substantially common image are laid out is displayed on a user interface, an image picture selected by a user is specified, a commodity image exhibiting the same image or an analogous image as the selected image picture is picked up from a database, and an electronic catalog is generated therefrom and displayed. Accordingly, an electronic catalog containing only commodity images more suitable for user's preferences may be generated and presented to the user, which may increase a user's needs for purchasing and may spread the use of the online shopping.

However, even in Patent Document 1, it is useless selecting commodities more suitable for the user's image thereof if an image per se does not occur, for example, if the user does not know what are required for entrance to school or company. Patent Document 1: JP 2002-133291 A

### SUMMARY

The present invention has been made in view of the above-mentioned respect, and a primary object thereof is to propose a technique in which a proposer that has verified actual commodities presents to a user an optimum commodity combination example (group commodity) based on a purpose so as to allow the user to purchase commodities as the group commodity, and an incentive is given to the proposer that has proposed the group commodity when the group commodity is sold, which activates a consumer behavior in online shopping.

Further, in the online shopping, it may be considered that users purchase not only commodities but also a service related to delivery of the commodities at the same time. That is, the above-mentioned service corresponds to fees for packing a commodity purchasing of which has been decided and fees related to the delivery, and a cost thereof is borne by one of a retailer on the online shopping site and a purchaser. Here, even in a case where the cost is borne by the retailer on the online shopping site, the cost related to the delivery service is finally passed onto a purchase price for the purchaser. Here, the cost related to the delivery service generally varies depending upon the number of delivery lots and a cubic content of a carton for delivery, but in the conventional commodity purchasing action, such a service as to allow delivery for free if a purchase amount is equal to or larger than a predetermined amount has been in the main stream, which has led to a current situation in which the delivery cost is not allocated appropriately. Therefore, a secondary object of the present invention is to propose a technique capable of allowing a purchaser to select appropriate cost bearing on his/her own by informing a user of a packing state, which exerts a direct influence upon the delivery cost, at a time of purchasing in real time.

One of aspects of the present invention is a group commodity purchasing system for performing a purchasing operation by causing a commodity list to be downloaded and displayed onto a user terminal, the commodity list being generated based on commodities that are registered in a database of a server coupled thereto via a network.

The group commodity purchasing system includes the server and the database of the server. The database includes a commodity master in which at least a commodity code and a price are associated with each other, and a group commodity table for registering a group of commodities selected arbitrarily by a specific user as a group commodity, in which individual commodity codes, a total price, and a single group commodity code that is newly assigned to the group of commodities when the specific user finishes selecting commodities constituting the group of commodities are associated with one another.

The server reads the group commodity code from the group commodity table and registers the group commodity code as one of the commodity codes on the commodity master, the group commodity code registered on the commodity master being displayed in the commodity list for a user assigning at least one commodity to be purchased.

When the group commodity code is assigned as a commodity to be purchased by the user terminal via the network, the server retrieves individual commodity codes corresponding to the group commodity code, and performs an order processing regarding the individual commodity codes.

According to an aspect of the present invention, a proposer that has verified actual commodities presents to a user an optimum commodity combination example (group commodity) based on a purpose so as to allow the user to purchase commodities as the group commodity.

Further, it is possible to allow a purchaser to select appropriate cost bearing on his/her own by informing a user of a packing state, which exerts a direct influence upon the delivery cost, at a time of purchasing in real time.

### BRIEF DESCRIPTION OF THE DRAWINGS

FIG. 1 is a configuration diagram of a system according to the present invention.

FIG. 2 is a hardware configuration diagram of a server.

FIG. 3 is an explanatory diagram illustrating contents of a commodity master and a group commodity table.

FIG. 4 is an explanatory diagram illustrating contents of a commodity master, a proposer master, and a sales performance database.

FIG. 5 is a diagram illustrating a display screen presented to a user for proposing a group commodity.

FIG. 6 is an explanatory diagram illustrating contents of a commodity master and a packing material master.

FIG. 7 is an explanatory diagram illustrating contents of the commodity master and the packing material master for a case of making a group commodity proposal.

FIG. 8 is a diagram illustrating a display screen presented to the user for visually indicating a collective packing status.

FIG. 9 is a diagram illustrating a display screen presented to the user for visually displaying the collective packing status and for proposing other commodities.

FIG. 10 is a diagram illustrating a display screen presented to the user for visually displaying the collective packing status and for proposing other commodities.

FIG. 11 is a diagram illustrating a display screen presented to the user for a case of conducting an all-you-can-pack service.

FIG. 12 is an explanatory diagram of a case where tagging information is registered as additional information for the commodity master.

### DETAIL DESCRIPTION OF THE EMBODIMENTS

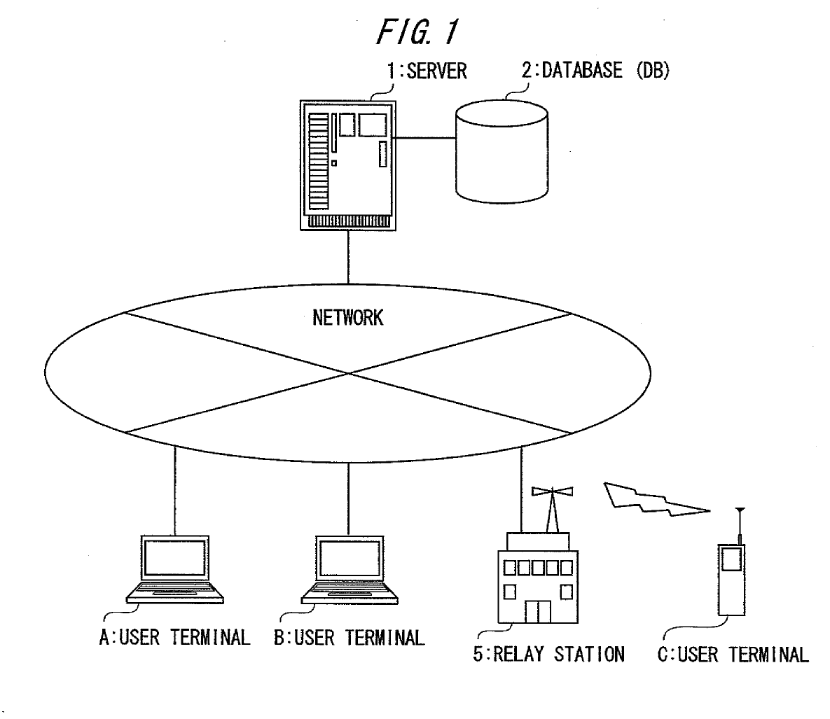

Hereinafter, description is made of embodiments of the present invention based on the figures. FIG. 1 is a configuration diagram of a system according to this embodiment. The system includes in terms of hardware, a server 1, a network 3, and user terminals A to C. Here, the user terminals A and B are personal computers that may be coupled to the network 3, and a mobile telephone terminal that may be coupled to the network 3 via a relay station 5 may be used as the user terminal C. Further, the server 1 includes a database (DB) 2 externally, but the database (DB) 2 may be a database server coupled directly to the network 3. Each of the user terminals A, B and C may access the server 1 via the network 3 to download and display information relating to an online shopping web site provided by the server 1. Each of the user terminals A, B and C sends information input by a user in accordance with the displayed information to the server 1 via network 3. The server 1 may execute various processings based on the information received from the each of the user terminals A, B and C.

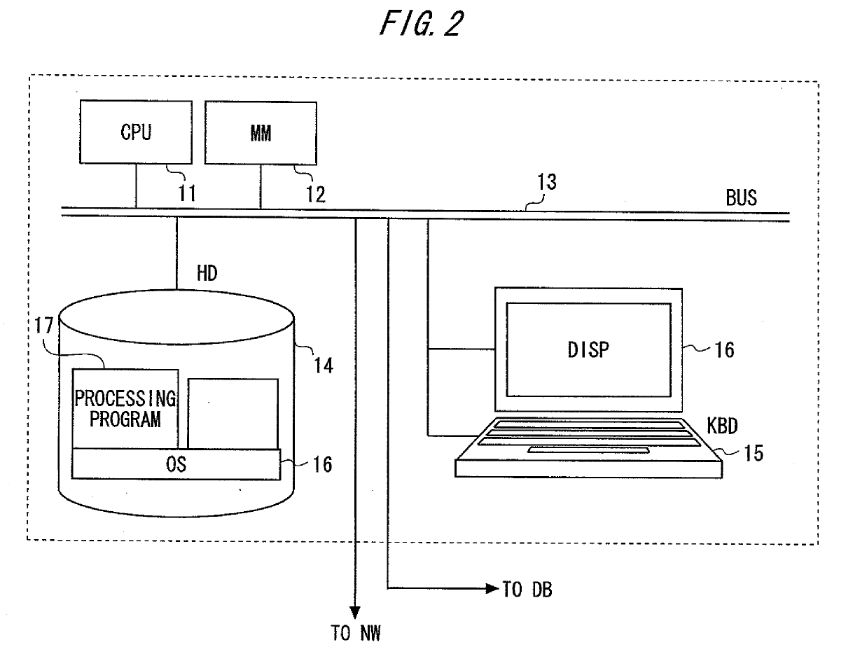

As illustrated in FIG. 2, the server is a general-purpose information processing device and includes a central processing unit (CPU) 11 as a main component, a main memory (MM) 12, a hard disk drive (RD) 14 coupled through a bus (BUS) 13, and a keyboard (KBD) 15 and a display device (DISP) 16 as input/output means.

The hard disk drive (HD) 14 has processing programs 17 registered as well as an operating system (OS) 16, and functions as the server 1 of this embodiment by having the processing programs 17 executed by being sequentially read into the central processing unit (CPU) 11 via the bus (BUS) 13.

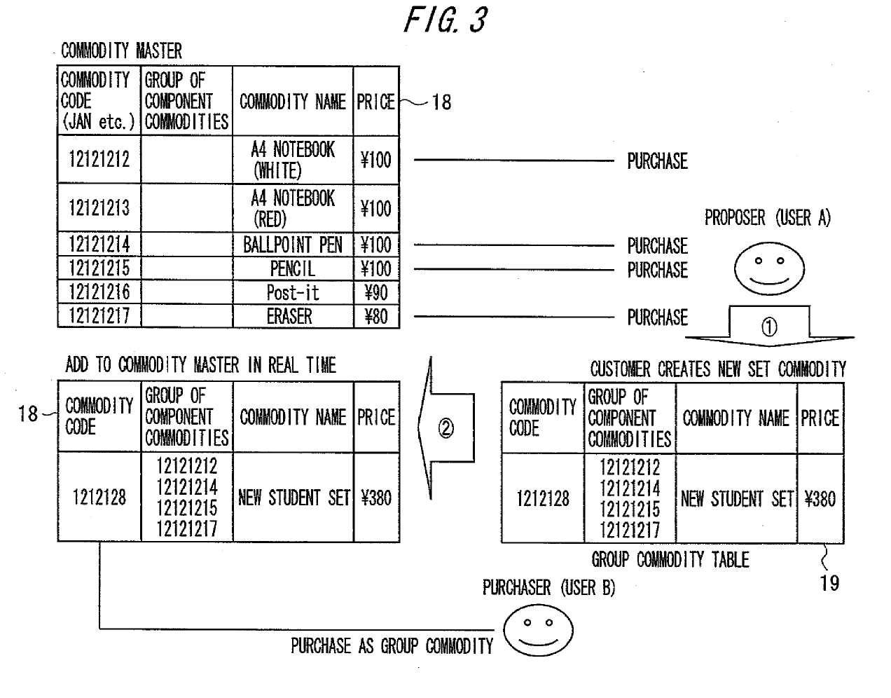

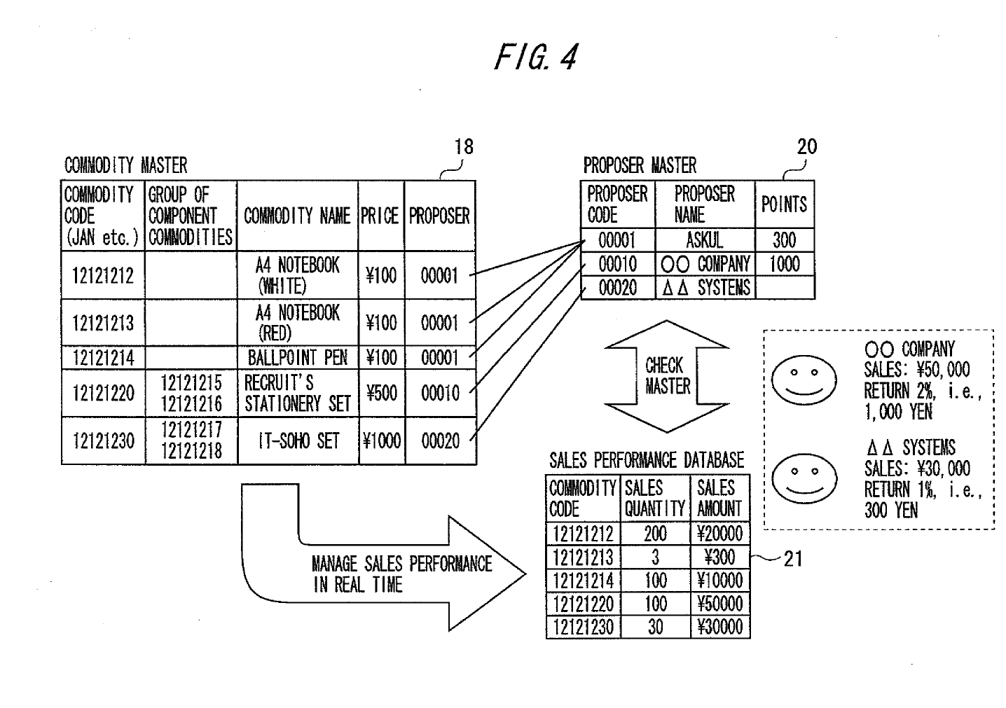

In addition, the database (DB) 2 includes a commodity master 18 and a group commodity table 19 that are illustrated in FIG. 3 and a proposer master (proposer database) 20 and a sales performance database 21 that are illustrated in FIG. 4.

Note that the user terminals A and B are personal computers, each having the same configuration as the server, illustration of which is omitted.

Further, the mobile telephone terminal can be used as the user terminal C, making it possible to purchase commodities or to propose group commodities described later via the mobile telephone terminal.

In the group commodity table of the database (DB) 2, a commodity code singly assigned to each group, individual codes of its component commodities, a commodity name, and a price of the group are registered in association with one another.

The group commodity table 19 allows a commodity specified by a proposer (user A) to be registered therein. In a case of proposing, for example, a new student set as a group commodity, the proposer (user A) may register a group commodity including an A4 notebook (white), a ballpoint pen, a pencil, and an eraser as an optimum combination based on his/her own experience under the name of “A's recommended entrance-to-school set”. The group commodity registration may be performed by following procedures. For example, one of the user terminals A, B and C accesses the server 1 to download a copy of the commodity master 18 and a form of the group commodity table 19 and to display them. The user, namely proposer, registers component commodities of the group commodity selected from the copy of the commodity master 18 and a group commodity name on the form of the group commodity table 19 to generate the group commodity table 19. The generated group commodity table 19 is sent to the server 1 from the one of the user terminals A, B and C and the server 1 registers contents of the group commodity table 19 on the commodity master 18 in the database 2.

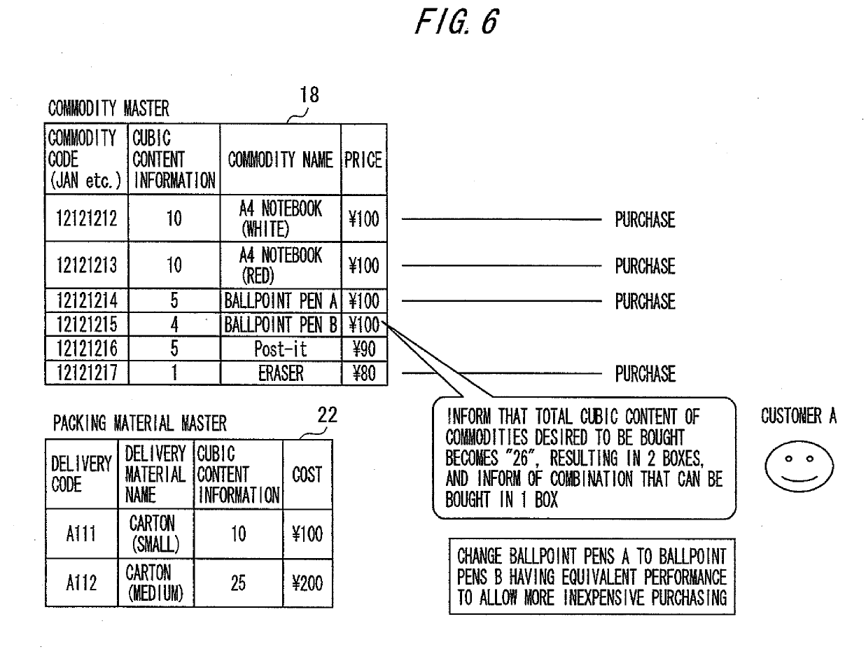

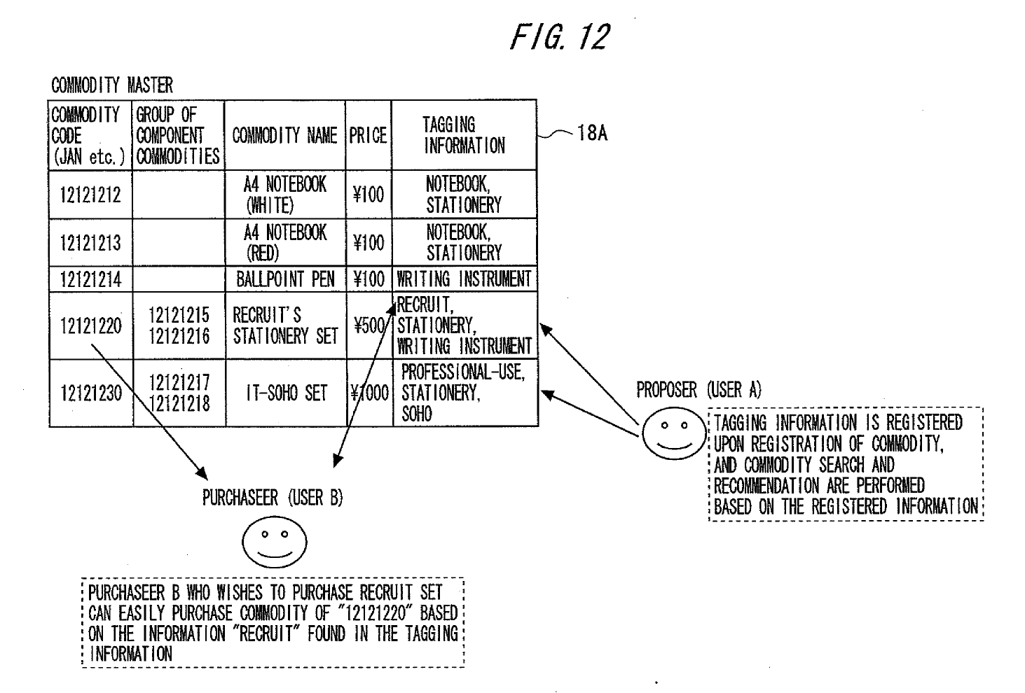

The contents of the thus-generated group commodity table 19 are sequentially registered in the commodity master 18 as they are. Thus, when the group commodity code in the generated group commodity table 19 is registered, as one of the commodity codes, on the commodity master 18, the server 1 may register a plurality of commodity codes in association with the group commodity code on the commodity master 18, the plurality of commodity codes indicating a plurality of commodities constructing a group specified by the group commodity code. At this time, in the commodity master 18, in addition to field items illustrated in FIG. 6, a word such as a category (for example, “stationery”) of a commodity or commodity group concerned or a related word (for example, “recruit”) for the commodity/commodity group may be registered as tagging information as illustrated in FIG. 12 (see the commodity master 18A). By thus registering the tagging information in the commodity master 18A in association with the commodity/commodity group, the commodity or commodity group concerned can be easily searched based on the category or the related word. Also in a case of proposing a new commodity group, the proposer (user) can retrieve the candidate commodity/commodity group with ease.

As described above, a single commodity code is assigned to the group commodity registered in the commodity master 18, and the individual commodity codes of its component commodities are also registered in association therewith. At this time, as illustrated in FIG. 4, a proposer code of the proposer (here, user A) that has proposed the group commodity concerned is registered in association therewith.

In the proposer master 20, the proposer code and the proposer concerned are registered in association with each other. Meanwhile, in the sales performance database 21, the commodity code, a sales quantity, and a sales amount are registered in association with one another.

Here, according to a totaling program, which is one of processing programs 17, the central processing unit (CPU) 11 of the server 1 calculates sales quantities and sales amounts of group commodities from the commodity master 18, and sums up the sales quantities and the sales amounts for each proposer. This makes it possible to calculate how many sales the proposed group commodities have generated for each proposer. When the proposed group commodity is actually sold as described above, an incentive based on the sales performance (for example, several percent thereof) is returned to the proposer. In this case, the returned amount is added to the proposer master 18 illustrated in FIG. 4 (the added state is not illustrated in the figure). Also, it maybe applied to a configuration that points as incentive in response to the sales performance is registered on the proposer master 20 as illustrated in FIG. 4.

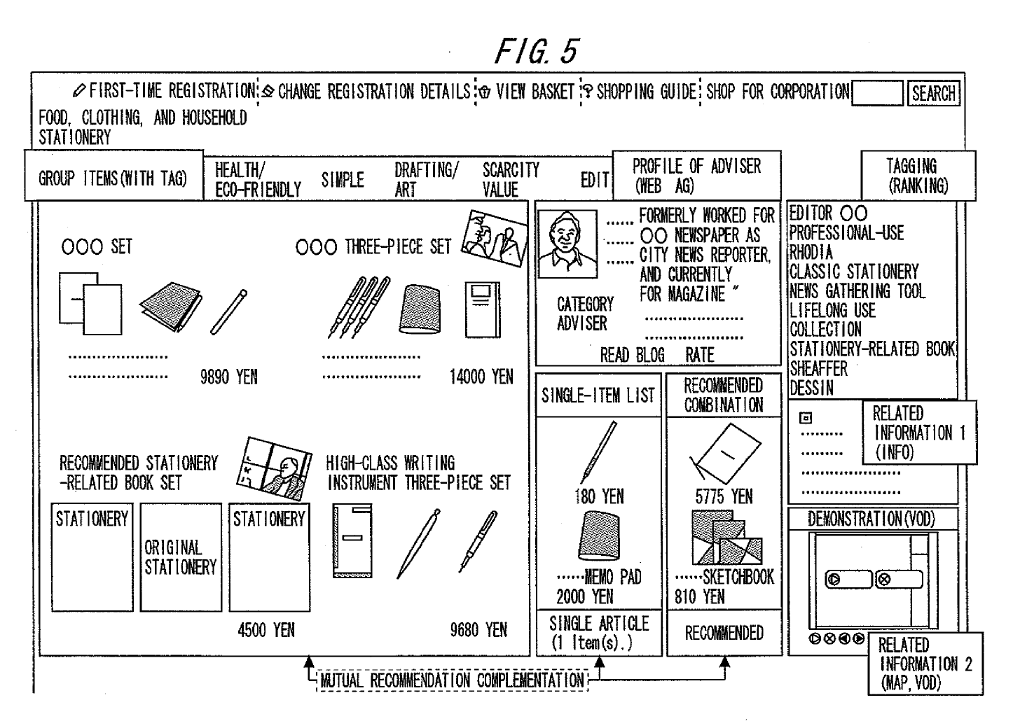

FIG. 5 is one example of a display screen presented to the user, which is generated by the central processing unit 11 of the server 1. As in the figure, a list of group commodities (commodity list), image data of each thereof, a profile of a proposer (adviser) are displayed. Each of the user terminals A, B and C may download the display screen from the server 1 via the network 3 to display the display screen. A user of each of the user terminals A, B and C may refer the display screen and performs purchase operations for online shopping. When the group commodity code is assigned at one of the user terminals A, B and C, the group commodity code is sent from the user terminal to the server 1 via the network 3. The central processing unit (CPU) 11 of the server 1 may retrieve individual commodity codes corresponding to the group commodity code received from the user terminal to execute order processing for a plurality of commodities having the individual commodity codes.

FIG. 6 illustrates a structure of another commodity master 18 according to this embodiment.

In the commodity master 18, the commodity coder cubic content information, the commodity name, and the price are registered in association with one another.

Here, the cubic content information is a parameter regarding a commodity volume, specifically representing a volume rate of the commodity concerned.

Meanwhile, the server 1 includes a packing material master 22, in which a delivery code, a delivery material name, the cubic content information (packing volume parameter), and a cost (price) are registered in association with one another. For example, a carton with the cubic content information (pack volume parameter) being “10” means that commodities can be packed collectively in the same carton until the total of the cubic content information (commodity volume parameter) of individual commodities reaches “10”. Therefore, in a step in which the user selects and purchases a commodity based on the commodity master 18, for example, it is possible for the central processing unit (CPU) 11 of the server 1 to reference the packing material master 22 to thereby notify (display to) the user that the total cubic content of commodities desired to be bought becomes “26” exceeding “25” which is the cubic content of a larger packing material, resulting in 2 boxes, and to thereby propose a combination thereof that can be bought in 1 box.

Further, by referencing the cubic contents, the user can change ballpoint pens A (cubic content of “5”) to ballpoint pens B (cubic content of “4”) having equivalent performance, without even changing the number thereof, to thereby increase the number of ballpoint pens that can be collectively packed in 1 box, which substantially allows more inexpensive purchasing thereof by suppressing a cost of the packing material.

Such cubic content information of the commodity master 18 may also be applied to the proposal of the above-mentioned group commodity.

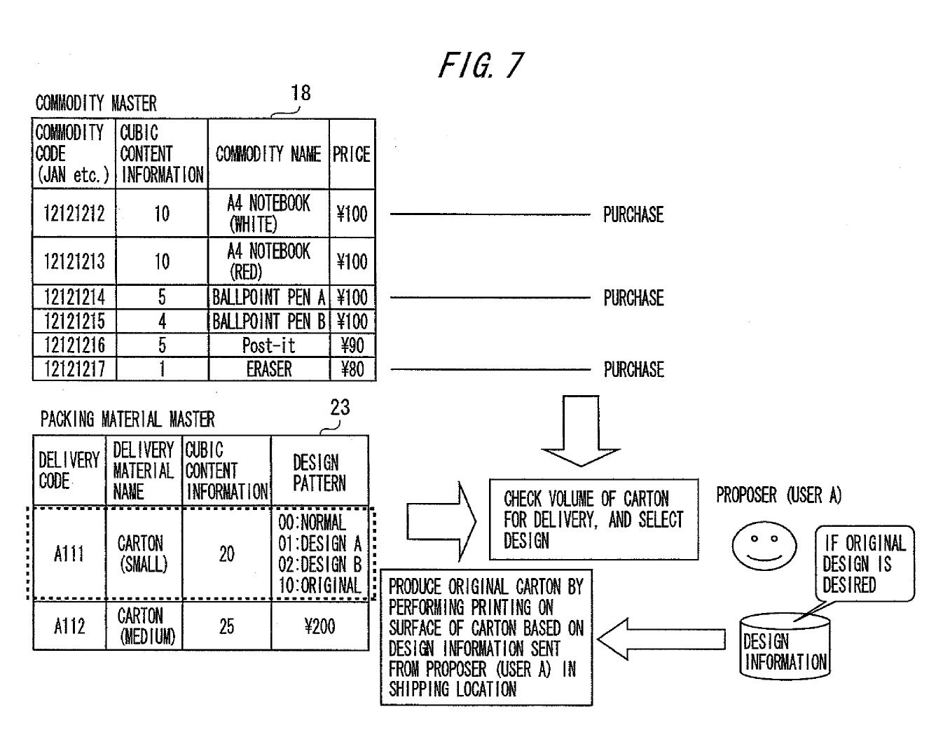

For example, as illustrated in FIG. 7, the proposer (user A) of the group commodity selects commodities from the commodity master 18 while checking a volume (pack volume parameter) of a carton for delivery in the packing material master 23. In addition, at this time, a design of the carton for delivery may be selected simultaneously.

Note that at this time, the proposer (user A) may create a design image on a surface of the packing material (carton) on his/her own or select the design image from among templates prepared on the server 1 in advance, and transmit the design image to the server as design information, while the server 1 may instruct a shipping server to print the design image on the surface of the carton to produce an original carton, and to collectively pack the selected group commodity therein.

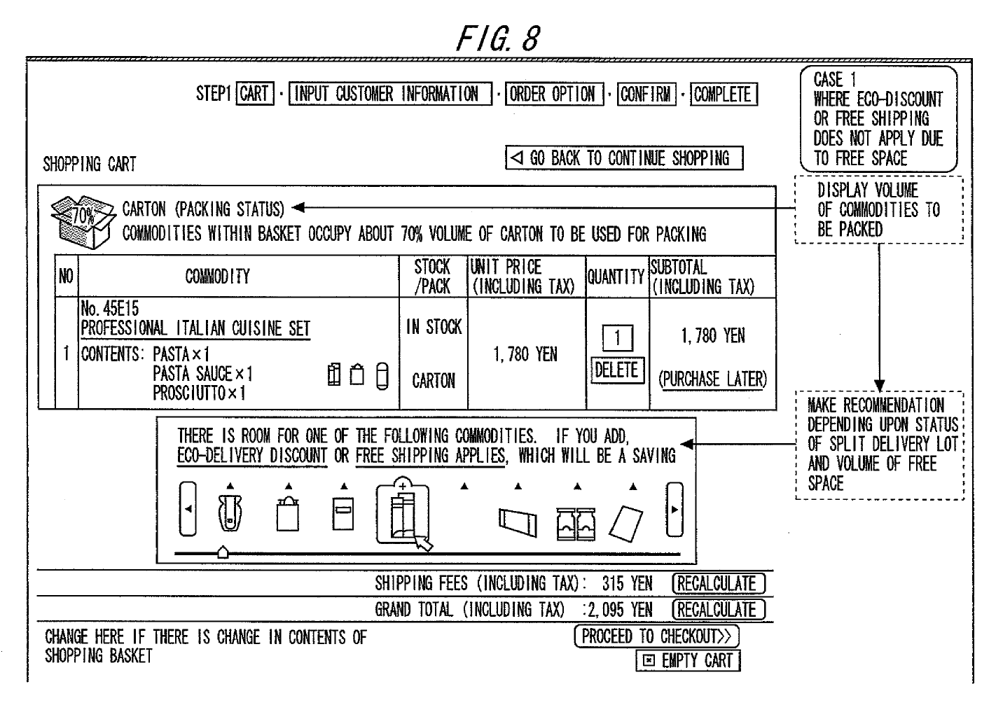

In FIGS. 8 to 11, conversion is performed into graphic data that may be visually recognized by the user based on the cubic content information (commodity volume parameter) of the commodity master 18 and the cubic content information (pack volume parameter) of the packing material master 22 or 23. To be specific, as illustrated in FIG. 8, a graphic of the carton is displayed, and the coloring of the carton graphic is changed based on a filling rate according to the packing status (for example, in a case where the filling rate is 70%, 70% of the carton graphic is changed in color).

The central processing unit (CPU) 11 of the server 1 executes following processings for calculating the filling rate. That is, the CPU 11 reads cubic content information corresponding to the commodity code assigned as a purchased commodity from the commodity master 18. The CPU 11 also reads cubic content information according to the delivery code from the packing material master 22 or 23. The CPU 11 subtracts a cubic content read from the commodity master 18 from a cubic content read from the packing material master 22 or 23 to obtain a free volume of the packing material and converts the free volume into a filling rate.

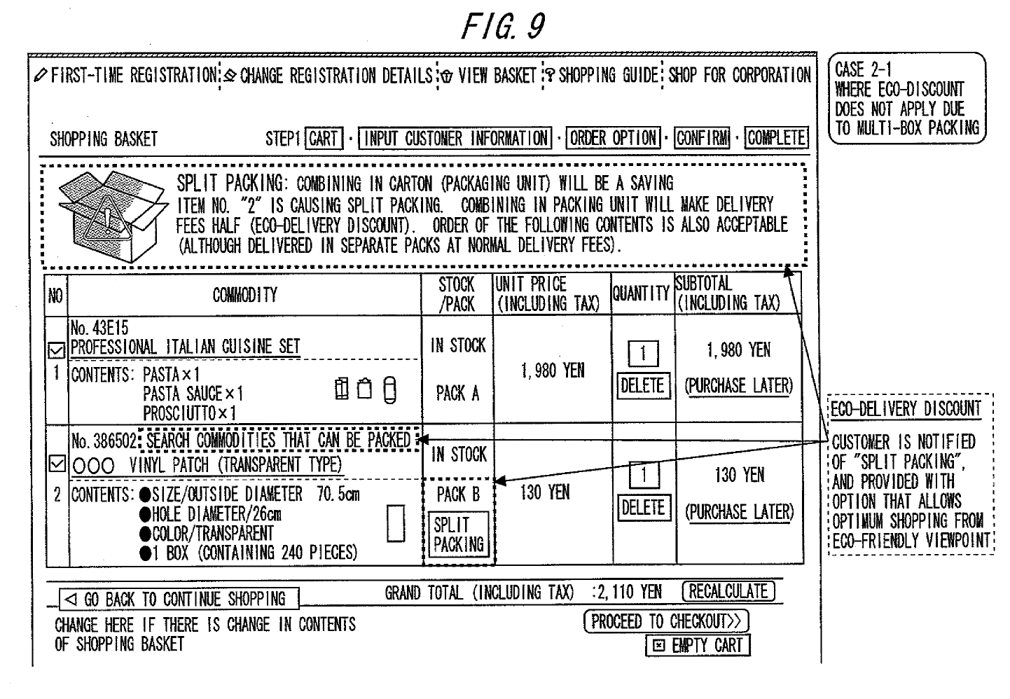

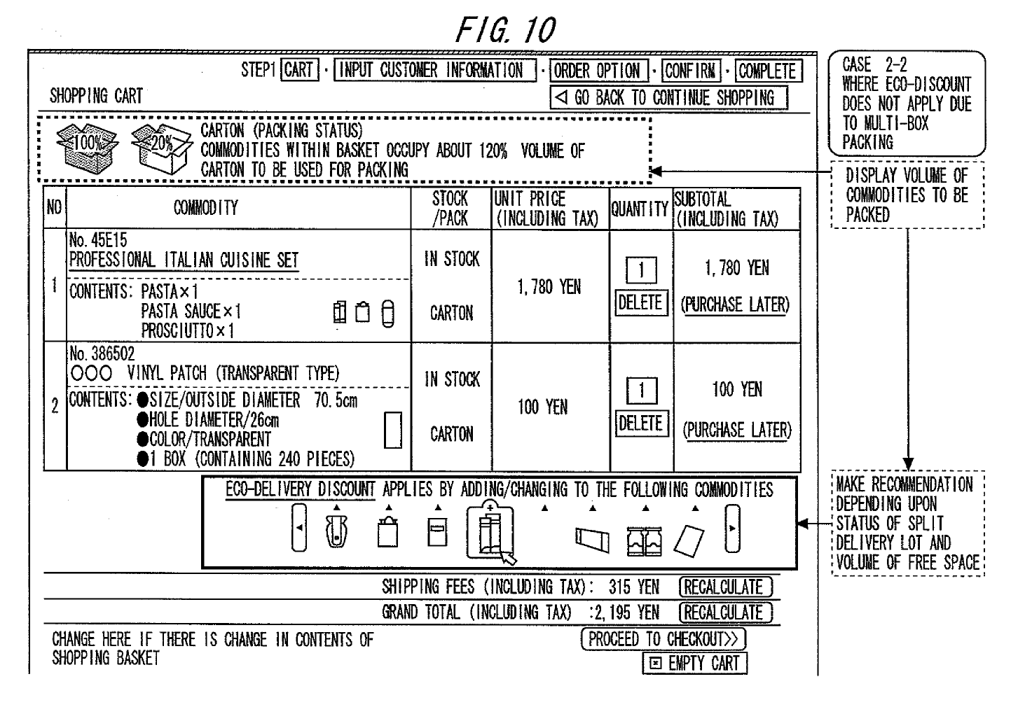

In addition, in FIGS. 9 and 10, a case where the commodities selected by the user may result in multi-box packing is presented, and an option for an optimum commodity selection is presented to the user.

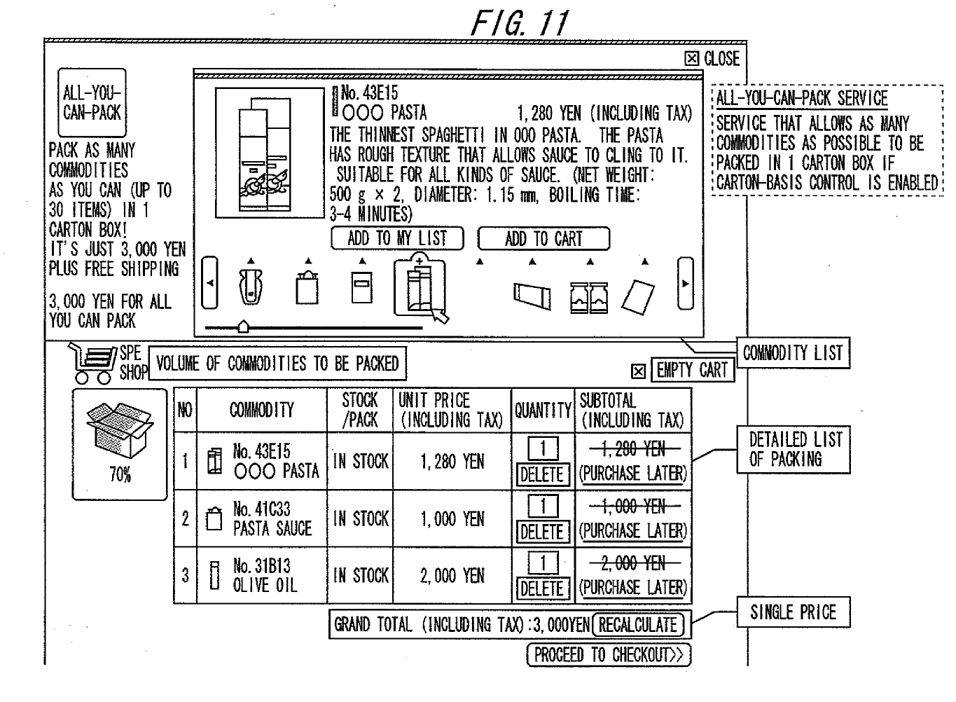

Further, in FIG. 11, based on the pack volume parameter of the packing material 22 or 23, commodities of the commodity master 18 may be packed in an all-you-can-pack manner until a numerical value of the pack volume parameter of the carton is reached, which makes it possible to suppress the cost of the packing material and a delivery cost.

The present invention can be used for online shopping.

1. A group commodity purchasing system for performing a purchasing operation by causing a commodity list to be downloaded and displayed on to a user terminal, the commodity list being generated based on commodities that are registered in a database of a server coupled thereto via a network, the group commodity purchasing system comprising:
the server; and
the database of the server including:
a commodity master in which at least a commodity code and a price are associated with each other, and
a group commodity table for registering a group of commodities selected arbitrarily by a specific user as a group commodity, in which individual commodity codes, a total price, and a single group commodity code that is newly assigned to the group of commodities when the specific user finishes selecting commodities constituting the group of commodities are associated with one another,
the server reading the group commodity code from the group commodity table and registering the group commodity code as one of the commodity codes on the commodity master, the group commodity code registered on the commodity master being displayed in the commodity list for a user assigning at least one commodity to be purchased, and
when the group commodity code is assigned as a commodity to be purchased by the user terminal via the network, the server retrieving individual commodity codes corresponding to the group commodity code, and performing an order processing regarding the individual commodity codes.

2. The group commodity purchasing system according to claim 1, wherein, when registering the group commodity code on the commodity master, the server registers the individual commodity codes on the commodity master in association with the group commodity code.

3. The group commodity purchasing system according to claim 1, wherein the commodity master contains a category of a component commodity and/or a related word therefor registered as tagging information in association with the commodity code for each commodity code.

4. The group commodity purchasing system according to claim 1, wherein:
the commodity master of the server contains a proposer ID associated with the group commodity code, the proposer ID identifying a proposer that proposes the group commodity;
the group commodity purchasing system further comprises:
a sales performance database corresponding to the group commodity code; and
a proposer database for managing the proposer ID and incentive in association with each other; and
the server references the sales performance database to additionally register the incentive decided based on sales performance in the proposer database.

5. A commodity purchasing system for performing a purchasing operation by causing a commodity list to be downloaded and displayed onto a user terminal, the commodity list being generated based on commodities that are registered in a database of a server coupled thereto via a network, the commodity purchasing system comprising:
the server; and
the database of the server including:
a commodity master in which at least a commodity code, an individual commodity volume parameter indicating a volume of a space that is occupied by a commodity having the commodity code at a time of its packing, and a price are associated with one another, and
a packing material master in which a code indicating a delivery material and a maximum packing volume parameter of the packing material are associated with each other,
the server reading, when a commodity code is assigned as a commodity to be purchased by the user terminal via the network, the packing volume parameter of the packing material from the packing material master, reading a commodity volume parameter of the commodity to be purchased from the commodity master, subtracts the commodity volume parameter from the pack volume parameter to calculate a volume of a free space within the packing material, converts the volume of the free space into graphic data that may be visually recognized, in order to cause the graphic data to be downloaded and displayed onto the user terminal via the network.

6. The commodity purchasing system according to claim 5, wherein, when another commodity code is additionally assigned as the commodity to be purchased by the user terminal via the network, the server reads the commodity volume parameter of the commodity to be purchased, which has been additionally specified, from the commodity master, further subtracts the commodity volume parameter of the added commodity from a volume of the free space calculated to calculate a new volume of the free space within the packing material, converts the new volume of the free space into a graphic data that may be visually recognized, in order to cause the graphic data to be downloaded/displayed onto the user terminal via the network.

7. A group commodity proposing system that allows a commodity selecting operation to be performed by causing a commodity list to be downloaded and displayed onto a user terminal for proposing a group commodity, the commodity list being generated based on commodities that are registered in a database of a server coupled thereto via a network, the group commodity proposing system comprising:
the server; and
the database of the server including:
a commodity master in which at least a commodity code assigned on an individual commodity basis or a group commodity basis, an individual commodity volume parameter indicating a volume of a space that is occupied by a commodity having the commodity code at a time of its packing, and a price are associated with one another; and
a packing material master in which a code indicating a delivery material and a maximum packing volume parameter of the packing material are associated with each other,
wherein, when the commodity code is specified as the proposed group commodity by the user terminal via the network, the server reads the pack volume parameter of the packing material from the packing material master, reads a commodity volume parameter of the commodity from the commodity master, subtracts the commodity volume parameter from the pack volume parameter to calculate a volume of a free space within the packing material, converts the volume of the free space into graphic data that can be visually recognized, and causes the graphic data to be downloaded/displayed onto the user terminal via the network, to thereby allow visual grasp of how much space of the packing material is occupied by the group commodity proposed by a user.
